(19) United States
(12) Patent Application Publication
(10) Pub. No.: US 2014/0185116 A1
(43) Pub. Date: Jul. 3, 2014

(54) SCANNING MIRROR DEVICE

(71) Applicant: Funai Electric Co., Ltd., Osaka (JP)

(72) Inventor: Kouichi Kugo, Osaka (JP)

(73) Assignee: FUNAI ELECTRIC CO., LTD., Osaka (JP)

(21) Appl. No.: 14/046,264

(22) Filed: Oct. 4, 2013

(30) Foreign Application Priority Data
Dec. 27, 2012 (JP) 2012-283840

(51) Int. Cl. G02B 26/10

(52) U.S. Cl. CPC G02B 26/101; G02B 26/10
USPC 359/198.1

(57) ABSTRACT

A scanning mirror device includes a mirror, a first supporting body that supports the mirror, a plurality of securing materials that has higher rigidity than the first supporting body and supports the first supporting body, a reinforcing material that has higher rigidity than the first supporting body and is attached to the plurality of securing materials on a surface different from a surface on which the mirror is disposed, and a first driving portion that deforms the first supporting body so as to cause the mirror to be displaced around a first axis.

### FIELD OF TECHNOLOGY

The present invention relates to a scanning mirror device for displacing, around two perpendicular axes, a mirror that reflects a laser beam.

### BACKGROUND ART

A scanning mirror device for causing a mirror that reflects a laser beam to undergo reciprocating displacements around two perpendicular axes to scan the reflected beam in the vertical and horizontal directions to display an image by the laser beam is used in image displaying devices such as, for example, laser projectors and the like.

Patent Citation 1 discloses a deflecting device uses a piezo actuator wherein a mirror portion and a piezo cantilever supporting body of a piezo actuator that drives the mirror portion are formed integrally through performing a shaping process on a semiconductor substrate formed from a plurality of layers, where the piezo cantilever supporting body is formed through performing a forming process on a first supporting layer comprising at least one of the plurality of layers and the mirror portion is formed through performing a forming process on a second supporting layer formed from at least one of the plurality of layers having a thickness different from that of the first supporting layer.

### PRIOR ART CITATIONS

### Patent Citation

[Patent Citation 1] Japanese Unexamined Patent Application Publication 2009-169290

In a scanning mirror device wherein a mirror that reflects a laser beam undergoes reciprocating displacement in a horizontal scanning direction and a vertical scanning direction through deformation, in accordance with a driving signal, a supporting body that supports a mirror, there is the need to reduce the member mass and the moment of inertia in order to increase the resonant frequency of the driving signal to cause the reciprocating displacement of the mirror.

On the other hand, in order to cause the mirror to undergo displacement according to the design through deformation of the supporting body, it is necessary to limit the deformation of the supporting body to that which is specified, and thus a member with relatively high rigidity is provided for the supporting body in order to limit the deformation.

That is, the need to provide a member with relatively high rigidity, in order to limit the deformation of the supporting body, and the need to reduce the mass and the moment of inertia of the supporting body are in opposition to each other, and it is desirable to handle these needs rationally.

### SUMMARY OF THE INVENTION

One or more embodiments of the present invention provide a high performance scanning mirror device.

In general, the scanning mirror device according to one or more embodiments may comprise: a mirror; a first supporting body that supports the mirror; a plurality of securing materials that has higher rigidity than the first supporting body and supports the first supporting body; a reinforcing material that has higher rigidity than the first supporting body and is attached to the plurality of securing materials on a surface different from a surface on which the mirror is disposed; and a first driving portion that deforms the first supporting body so as to cause the mirror to be displaced around a first axis.

In one or more embodiments, for example, the first axis may be provided at the axis for causing the mirror to undergo oscillating displacement in the horizontal scanning direction, to enable horizontal scanning of the laser that is reflected by the mirror through deformation of the first supporting body.

In one or more embodiments, for example, the reinforcing material may be rigid and may limit deformation in the securing materials, i.e., limit the deformation of the first supporting body. The reinforcing material may be, in one example, a straight-line rod shape, making it possible to reduce the mass and the moment of inertia.

In one or more embodiments, for example, two securing materials may be provided, so as to support two places of the first supporting body, but, depending on the need to constrain the deformation of the first support body to that which is specified, support may be in less than or more than two places.

While functional components of a variety of types and shapes may be used as the first driving portion, in one or more embodiments the size of the structure can be reduced through providing, on the first supporting body, a first driving portion of an auto-deforming type, e.g., a piezo-actuator.

One or more embodiments of the present invention may further comprise, for example, a second supporting body that has lower rigidity than the plurality of securing materials and the reinforcing material and that supports the first supporting body through the securing materials; and a second driving portion that causes the second supporting body to deform to cause the mirror, together with the first supporting body, to be displaced around a second rotational axis perpendicular to the first rotational axis.

In one or more embodiments, for example, the second axis may be provided at the axis for causing the mirror to undergo oscillating displacement in the vertical scanning direction, to enable vertical scanning of the laser that is reflected by the mirror through deformation of the first supporting body.

In one or more embodiments, for example, the first supporting body may have, through the reinforcing material, the rigidity thereof increased as required for the mirror to not deform unnecessarily, not even through the deformation of the second supporting body, so the mirror can achieve desirable vertical scanning and horizontal scanning

While functional components of a variety of types and shapes may be used as the second driving portion, the size of the structure can be reduced easily through providing, on the second supporting body, a second driving portion of an auto-deforming type, such as a piezo actuator.

In one or more embodiments, for example, the reinforcing material and the first supporting body and second supporting body may be formed through a variety of materials, and the reinforcing material may have relatively high rigidity, and the first supporting body and the second supporting body may have the relatively low rigidity.

In one or more embodiments, for example, the scanning mirror device may be an MEMS (Micro Electro Mechanical System) scanning mirror device. While the MEMS-type scanning mirror device may be formed to a size of, for example, about 10 mm×10 mm using a thin-film forming technology for semiconductor materials, such as silicon, or a thin-film forming technology for metals, and forming the reinforcing material from silicon and forming the first supporting the body and second supporting body from metal may make setting the respective required rigidities easier.

In one or more embodiments, for example, the scanning mirror device may be formed so as to avoid the reinforcing material overlapping the mirror in the normal direction of the mirror. Doing so may make it possible to perform the assembly operation of the periphery of the mirror easily, and may enable both the front and the back of the mirror to be used in reflecting the laser beam.

In one or more embodiments, for example, a shape wherein the reinforcing material is curved so as to avoid the mirror, or a shape wherein the reinforcing material is shaped with an opening portion corresponding to the mirror, may also be used.

In one or more embodiments, for example, at least the portion of the reinforcing material that overlaps the mirror in the normal direction of the mirror may be formed from a transparent material, enabling both the front and the back of the mirror to be used in reflecting the laser beam.

In general, one or more embodiments of the present invention may also be an image displaying device provided with a scanning mirror device as described above.

The image displaying device according to one or more embodiments may be an image displaying device for displaying an image by emitting a laser beam and reflecting the laser beam by causing a mirror to undergo scanning displacement, comprising: a first supporting body that supports the mirror; a plurality of securing materials that has higher rigidity than the first supporting body and supports the first supporting body; a reinforcing material that has higher rigidity than the first supporting body and is attached to the plurality of securing materials on a surface different from a surface on which the mirror is disposed; a first driving portion that deforms the first supporting body to cause the mirror to perform horizontal scanning displacement; a second supporting body that has lower rigidity than the plurality of securing materials and the reinforcing material and that supports the first supporting body through the securing materials; and a second driving portion that causes the second supporting body to deform to cause the mirror, together with the first supporting body, to perform vertical scanning displacement.

One or more embodiments of the present invention may enable an improvement in the performance of a scanning mirror device wherein a mirror is displaced through deformation of a supporting body.

### BRIEF DESCRIPTIONS OF THE DRAWINGS

FIG. 1 is a perspective diagram of a scanning mirror device according to a first embodiment of the present invention.

FIG. 2 is a perspective diagram illustrating the critical portions of a scanning mirror device according to the first embodiment of the present invention.

FIG. 3 is a perspective diagram viewing the scanning mirror device according to the first embodiment of the present invention viewed from the back side.

FIG. 4 is a diagram for explaining the critical portions of the first embodiment of the present invention, wherein (a) is a cross-sectional diagram and (b) is a plan view diagram.

FIG. 5 is a perspective diagram viewing the scanning mirror device according to a second embodiment of the present invention viewed from the back side.

FIG. 6 is a diagram for explaining the critical portions of the second embodiment of the present invention, wherein (a) is a cross-sectional diagram and (b) is a plan view diagram.

FIG. 7 is a perspective diagram viewing the scanning mirror device according to a third embodiment of the present invention viewed from the back side.

FIG. 8 is a diagram for explaining the critical portions of the third embodiment of the present invention, wherein (a) is a cross-sectional diagram and (b) is a plan view diagram.

### DETAILED DESCRIPTION OF THE INVENTION Embodiments of the present invention will be explained in a specific set based on examples that are presented as embodiments.

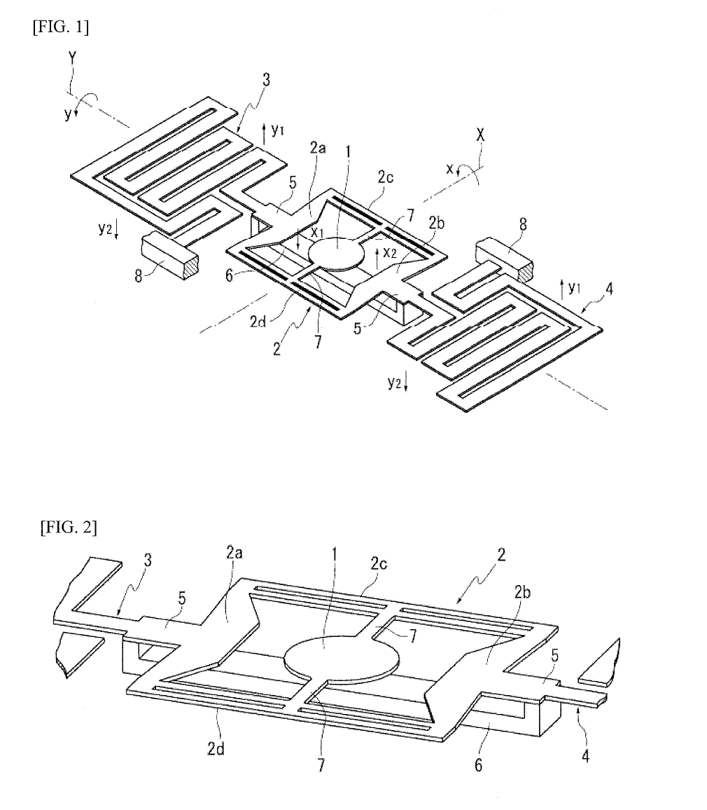

FIG. 1 through FIG. 4 illustrate a scanning mirror device according to a first embodiment of the present invention.

The scanning mirror device in the present example may include a mirror 1, a frame-shaped first supporting body 2, a pair of serpentine second supporting bodies 3 and 4, a pair of securing materials 5 for attaching the first supporting body and the second supporting bodies 3 and 4, and a reinforcing material 6 that attaches to these securing materials 5.

The scanning mirror device may be fabricated using a thin-film forming technology for semiconductor materials, such as silicon, or a thin-film forming technology for metals. The individual structures described above may be formed on, for example, a silicon substrate (Si substrate) that has a thickness of about 0.1 mm. For example, the first supporting body 2 may have a thickness of about 0.1 mm and an outside shape of about 10 mm×10 mm, excluding the first driving portion, described above.

This scanning mirror device may be an MEMS-type scanning mirror device, and may have benefits in terms of reducing size, reducing power consumption, increasing processing speed, and the like.

As illustrated in the example of FIG. 1, the mirror 1 may undergo reciprocating movement or displacement using, as rotational axes, two perpendicular axes X and Y that pass through the center of a disk-shaped mirror 1. The mirror 1 may be positioned in the plane of the axes X and Y, and the first supporting the body 2, the second supporting bodies 3 and 4, and the securing materials 5 may also be positioned in the same plane as the mirror 1.

The reinforcing material 6 may attach to the securing materials 5 at a surface different from the plane wherein the mirror 1 exists.

The mirror 1 may be given a mirror surface treatment through, for example, the fabrication of a metal thin-film on an Si substrate, where a laser beam incident on the mirror surface is reflected.

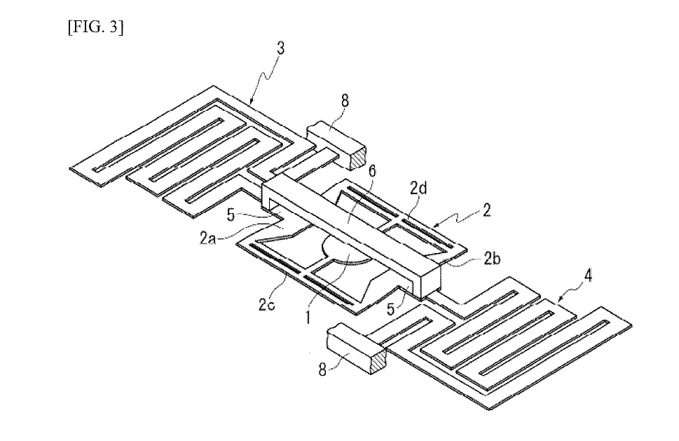

The mirror in the present example may be provided with a mirror surface on the front face side as illustrated in FIG. 1 and FIG. 2, but may not be provided with a mirror surface on the back face side, as illustrated in FIG. 3.

The first supporting body 2 may be formed in a frame shape from a pair of first driving portions 2a and 2b parallel to the rotational axis X, and a pair of attaching portions 2c and 2d that connect together both end portions of the first driving portions 2a and 2b. Each of these portions 2a through 2d may be formed with relatively low rigidity, and the first supporting body 2 itself may be deformable.

The first driving portions 2a and 2b formed protruding in a flange shape may have a bottom electrode layer, a piezoelectric body layer, and a top electrode layer provided as a thin layered body on an Si substrate, to form piezoelectric actuators.

Continuing with this example, when voltages of mutually of opposite phases are applied to the first driving portions 2a and 2b, the piezoelectric body layers may extend or contract depending on the voltage, so that the first driving portion 2a and the second driving portion 2b repetitively deform in mutually opposite directions in the directions that are orthogonal to the axes X and Y (the x1 direction and the x2 direction shown in FIG. 1).

The piezoelectric body layer of the piezoelectric actuator may be made from, for example, lead zirconate titanate (PZT), and through being polarized in the direction of thickness of the film layer, may extend or contract when a voltage is applied.

Such a piezoelectric actuator may be well-known, for example, as disclosed in Japanese Unexamined Patent Application Publication 2011-141333.

When, as described above, the first driving portions 2a and 2b are deformed repetitively in opposing directions (the x1 direction and to the x2 direction), the attaching portions 2c and 2d may be tilted, through these deformations, centered on the rotational axis X. A mirror 1 may be attached through a pair of bars 7, which may extend on the rotational axis X to the attaching portions 2c and 2d, where the tilting of the attaching portions 2c and 2d centered on the rotational axis X may cause the mirror 1 to undergo rotational displacement around the rotational axis X.

As illustrated in FIG. 1, when the first driving portion 2a deforms in the x1 direction and the first driving portion 2b deforms in the x2 direction, the mirror 1 may undergo rotational displacement in the x direction around the rotational axis X, and, conversely, when the first driving portion 2a deforms in the direction opposite of x1 and the first driving portion 2b deforms in the direction opposite from x2, the mirror 1 may undergo rotational displacement in the direction opposite from x, around the rotational axis X. Consequently, the mirror 1 can be caused to be displaced around the rotational axis X through the deformation of the first supporting body 2 itself.

The mirror 1 can be rotationally displaced in the opposite direction as described above, around the rotational axis X, by reversing the voltages applied to the first driving portions 2a and 2b.

Consequently, it is possible control the voltages applied to the first driving portions 2a and 2b to cause the mirror 1 to be displaced around the rotational axis X to scan a laser beam incident on the mirror 1. For example, if the scanning direction is the horizontal scanning direction, then the laser beam is scanned in the horizontal direction through control of the voltages applied to the first driving portions 2a and 2b.

As with the first supporting body 2, the second supporting bodies 3 and 4 may be formed with relatively low rigidity, and the second supporting bodies 3 and 4 themselves may deform, and piezoelectric actuators may be formed on an Si substrate, wherein a bottom electrode layer, a piezoelectric body layer, and a top electrode layer are provided as a layered body.

The second supporting bodies 3 and 4 may be formed so that both end portions thereof are displaced in opposite directions (the y1 direction and the y2 direction shown in FIG. 1) when the piezoelectric body layers extend or contract in response to voltages when voltages are applied, so that the second supporting bodies 3 and 4 tilt, as a whole, around the rotational axis Y.

In the present embodiment, the second supporting bodies 3 and 4 may form second driving portions that deform so as to cause the first mirror to displace, together with the first supporting body 2, around the rotational axis Y perpendicular to the rotational axis X.

As described above, the tilting of the second supporting bodies 3 and 4 may cause the first supporting body 2, which is attached through securing materials 5, to similarly tilt as a whole around the rotational axis Y, and the mirror 1 may be rotationally displaced around the rotational axis Y.

As illustrated in FIG. 1, when one end portion of the second supporting bodies 3 and 4 deforms and is displaced in the yl direction and the other end portion of the second supporting bodies 3 and 4 deforms and is displaced in the y2 direction, then the mirror 1 may undergo rotational displacement in the y direction around the rotational axis Y, and, conversely, when the one end portion of the second supporting bodies 3 and 4 undergoes deformation and displacement in the direction opposite from yl and the other end portion of the second supporting bodies 3 and 4 undergoes deformation and displacement in the direction opposite to y2, then the mirror 1 may undergo rotational displacement in the direction opposite from y around the rotational axis Y. This makes it possible for the minor 1 to be displaced around the rotational axis Y through the deformation of the second supporting bodies 3 and 4 themselves.

The voltages applied to the second supporting bodies 3 and 4 can be reversed and displaced rotationally the mirror 1 around the rotational axis X in the opposite direction from that which is described above.

Consequently, the mirror 1 can be displaced around the rotational axis Y, to scan the laser beam incident on the mirror 1, through controlling the voltages applied to the second supporting both bodies 3 and 4. If, for example, this scanning direction is the vertical scanning direction, the laser beam is scanned in the vertical direction through controlling the voltages applied to the second supporting bodies 3 and 4.

As described above, the mirror 1 can be caused to be displaced rotationally around the rotational axis X through deformation of the first supporting body 2, and the mirror 1 can be caused to be displaced rotationally around the rotational axis Y through the deformation of the second supporting bodies 3 and 4.

In these second supporting bodies 3 and 4, the base ends may be attached to an external frame 8 having relatively high rigidity, and the first supporting body 2 may be supported, through the securing materials 5, by the tip ends thereof.

It is possible to increase the rigidity of the securing materials 5 to be higher than that of the first supporting body 2 or the second supporting bodies 3 and 4 through, for example, a method wherein the thickness is increased through depositing an SiO layer on a Si layer, or a method wherein the thickness is increased through depositing a metal layer on the Si layer.

Moreover, while in the present example the securing materials 5 are provided in two locations on the rotational axis Y to attach the first supporting body 2 and the second supporting bodies 3 and 4, depending on the need in the device design, or the like, the securing materials 5 may be provided in three or more required locations.

The securing materials 5 may be attached through a frame with high rigidity such as one encompassing the first supporting body 2.

For example, in the two-axis scanning piezoelectric MEMS scanning mirror device, as described above, there is the need to increase the resonant frequency while obtaining a large deflection angle on the low speed scanning axis (the vertical scanning axis).

Because of this, in an image displaying device provided with a scanning mirror device, it is possible to scan the low speed scanning axis even with a waveform that includes a segment that has high acceleration, such as a sawtooth wave. If the scanning could only be performed with low acceleration, then the scanning waveform in the vertical direction would be near to a sine wave, so the scanning spacing at the top and bottom edges of the projection screen, or the like, would not be uniform, which would cause a loss in quality in the image projected by the mirror 1, but if scanning could be performed at a high speed, then the scanning could be performed with essentially uniform spacing. Moreover, because this would allow the mirror 1 to be returned to the origin over a short blanking period, a long time interval could be used in drawing in the image.

As another example, a reinforcing material 6 with relatively high rigidity may be attached to the securing materials 5 on a surface different from the plane where in the mirror 1 exists.

The reinforcing material 6 may be a rod shape that has a straight line shape that extends on the back face side of the mirror 1. When compared to the case of attaching the securing materials 5 by a frame, the mass may be reduced and the moment of inertia may be reduced through the mass being concentrated near the rotational axis Y, thus making it possible to operate the mirror 1 with a high-frequency driving signal while obtaining a large deflection angle (scanning displacement amplitude).

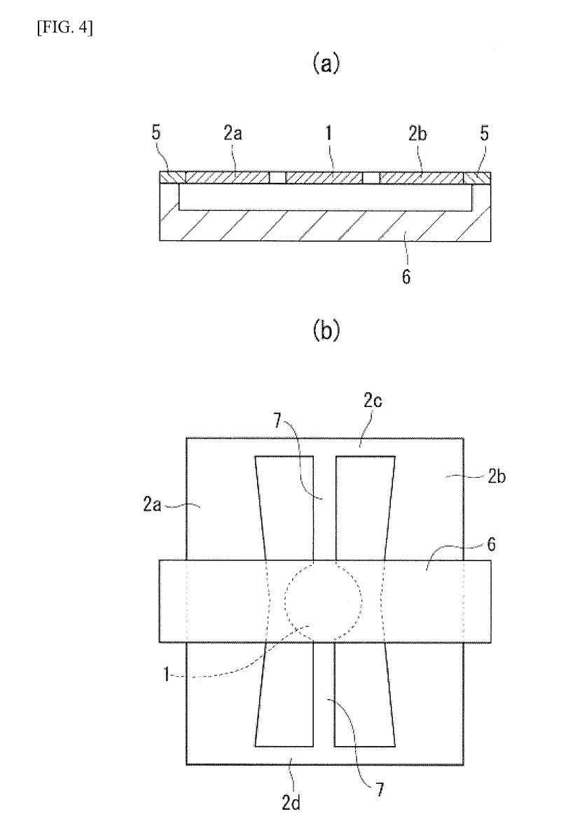

While, as illustrated in FIG. 4, the reinforcing material 6 may extend overlapping the mirror 1 in the normal direction of the mirror 1, the reinforcing material 6 may also be provided on the back face side of the mirror 1, so as not to interfere with the reflection of the laser beam by the mirror surface of the mirror 1.

The reinforcing material 6 may be resistant to deformation by forces such as compression, tension, twisting, and the like, and can be fabricated from a variety of materials insofar as they have these properties. For example, the reinforcing material 6 may be formed from a material with a large modulus of elasticity (Young's modulus/density) when compared to that of the easily deformed first supporting body 2 and second supporting bodies 3 and 4.

Moreover, the easily deformed first supporting body 2 and second supporting bodies 3 and 4 may be formed from metal, and the reinforcing material 6 may be formed from silicon, where such a structure can be manufactured easily using a thin film forming technology for a semiconductor material such as silicon and a thin film forming technology for metal. This may improve the ability to withstand physical shock and in terms of durability, and has the benefit of being able to reduce materials costs.

The reinforcing material 6 may be formed integrally with the securing materials 5, but, conversely, the reinforcing material may be formed as a separate component and the reinforcing material 6 may be attached through adhesion, or the like, to the securing materials 5.

The scanning mirror device set forth above can be provided in an image displaying device such as a laser projector, or the like, making it possible to increase the oscillating frequency while obtaining a high deflection angle on the low speed scanning axis of the mirror 1, while preventing extraneous oscillation in non-sinusoidal scanning

For example, in an image displaying device that displays an image by emitting a laser beam, based on a video signal, and causing a mirror to undergo scanning displacement to reflect the laser beam, the structure may be provided with a first supporting body 2 that supports a mirror 1 and that deforms to cause the mirror 1 to undergo scanning displacement around a first rotational axis X (for example, the horizontal scanning axis), securing materials 5 that support the first supporting body 2, a reinforcing material 6 that is attached to the securing materials 5 on a surface different from the plane wherein the mirror 1 exists, and second supporting bodies 3 and 4 that support the first supporting body 2, through the securing materials 5, and that undergo deformation to cause the mirror 1, together with the first supporting body 2, to undergo scanning displacement around a second rotational axis Y (for example, the vertical scanning axis).

For example, for scanning around the horizontal scanning axis (the first rotational axis X), the piezoelectric actuator of the first supporting body 2 may be resonance driven at a resonant frequency of about 30 kHz to cause the mirror 12 undergo reciprocating displacement at a relatively high speed. For scanning around the vertical scanning axis (the second rotational axis Y), the piezoelectric actuators of the second supporting bodies 3 and 4 may be resonance driven to cause the mirror 1 to undergo reciprocating displacement at a relatively low speed.

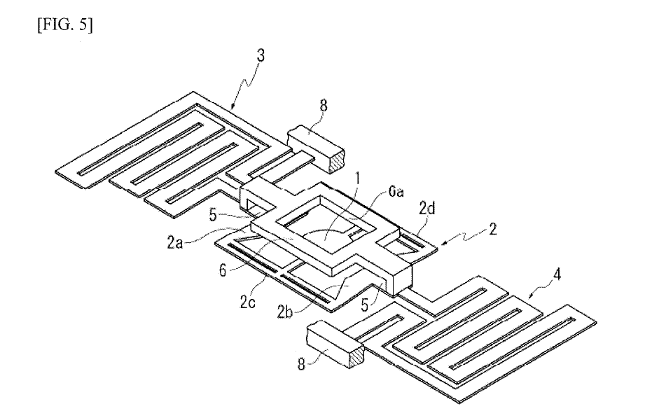

The reinforcing materials 6 may be provided on the back face side of the mirror 1 so as to extend overlapping the mirror 1, as discussed above, or instead, as illustrated in FIG. 5 through FIG. 8, for example, may be formed so as to avoid overlapping the mirror 1 in the normal direction of the mirror 1.

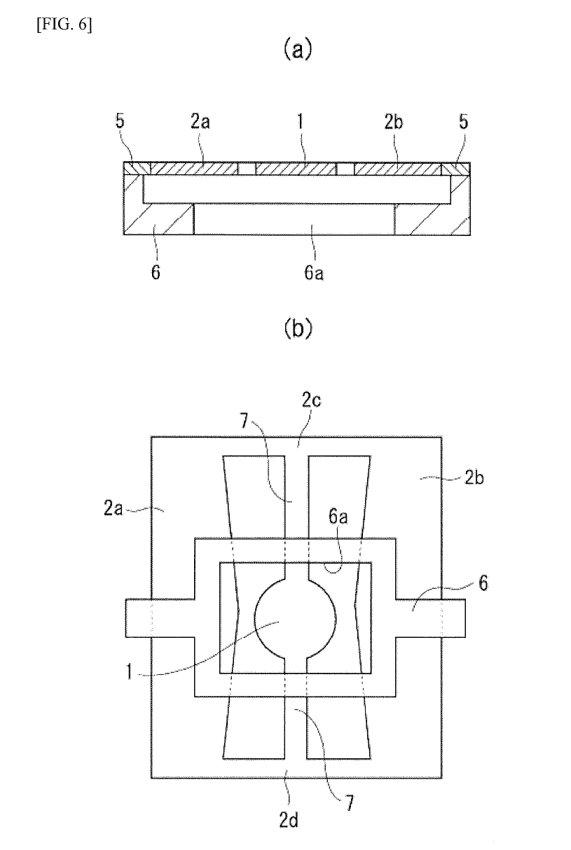

An example of a scanning mirror device according to a second embodiment of the present invention is illustrated in FIG. 5 and FIG. 6.

Those portions that are identical to those in the first embodiment, set forth above, are assigned identical codes and redundant explanations are omitted.

In the present embodiment, the reinforcing material may be shaped by forming an opening portion 6a in the center portion thereof, to avoid overlapping the mirror 1 in the opening portion 6a.

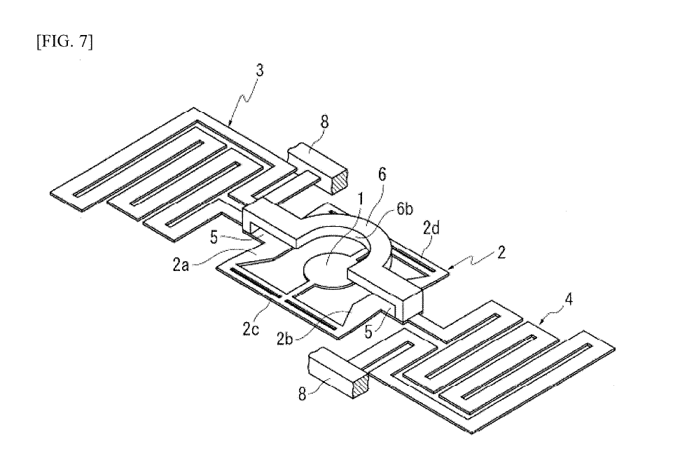

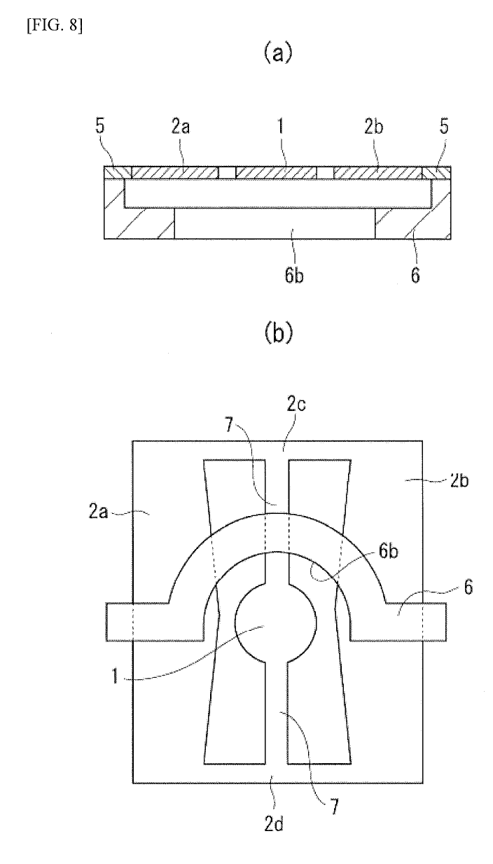

An example of a scanning mirror device according to a third embodiment of the present invention is illustrated in FIG. 7 and FIG. 8.

Those portions that are identical to those in the first embodiment, set forth above, are assigned identical codes and redundant explanations are omitted.

In the present embodiment, the reinforcing material may be shaped by forming a curved portion 6b in the center portion thereof, to avoid overlapping the mirror 1 in the curved portion 6b.

The shape of the reinforcing material 6 so as to avoid overlapping the mirror 1 in the normal direction of the mirror 1 can use a variety of shapes other than the examples set forth above.

Moreover, rather than a form wherein overlapping of the mirror 1 is avoided through the shape of the reinforcing material 6, the reinforcing material 6 may overlap the mirror 1 with at least that portion of the reinforcing material 6 that overlaps the mirror 1 in the normal direction of the mirror 1 formed from a transparent material.

Having the reinforcing material 6 not overlap the mirror 1 on the back face side of the mirror 1, or having that portion of the reinforcing material 6 that overlaps in the normal direction of the mirror 1 be transparent, makes it possible to provide a mirror face on the back face of the mirror 1, to enable use of both the front and back faces of the mirror 1 in reflecting the laser beam. For example, the use of both the front and back sides of the mirror 1 in scanning the laser beam can reduce the size and the cost of the equipment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### EXPLANATION OF CODES

1: Mirror

2: First Supporting Body

2a, 2b: First Driving Portions

3, 4: Second Supporting Bodies (Second Driving Portions)

5: Securing Materials

6: Reinforcing Material

6a: Opening Portion

6b: Curved Portion X: First Rotational Axis

Y: Second Rotational Axis

What is claimed is:

1. A scanning mirror device comprising:
a mirror;
a first supporting body that supports the mirror;
a plurality of securing materials that has higher rigidity than the first supporting body and supports the first supporting body;
a reinforcing material that has higher rigidity than the first supporting body and is attached to the plurality of securing materials on a surface different from a surface on which the mirror is disposed; and
a first driving portion that deforms the first supporting body so as to cause the mirror to be displaced around a first axis.

2. The scanning mirror device as set forth in claim 1, comprising:
a second supporting body that has lower rigidity than the plurality of securing materials and the reinforcing material and that supports the first supporting body through the securing materials; and
a second driving portion that causes the second supporting body to deform to cause the mirror, together with the first supporting body, to be displaced around a second rotational axis perpendicular to the first rotational axis.

3. The scanning mirror device as set forth in claim 1, wherein
the reinforcing material is formed from silicon, and
the first supporting body and the second supporting body are formed from metal.

4. The scanning mirror device as set forth in claim 1, wherein
the reinforcing material is formed to avoid overlapping the mirror in a normal direction of the mirror.

5. The scanning mirror device as set forth in claim 1, wherein
at least a portion of the reinforcing material that overlaps with the mirror in the normal direction of the mirror is formed from transparent material.

6. An image displaying device for displaying an image by emitting a laser beam and reflecting the laser beam by causing a mirror to undergo scanning displacement, comprising:
a first supporting body that supports the mirror;
a plurality of securing materials that has higher rigidity than the first supporting body and supports the first supporting body;
a reinforcing material that has higher rigidity than the first supporting body and is attached to the plurality of securing materials on a surface different from a surface on which the mirror is disposed;
a first driving portion that deforms the first supporting body to cause the mirror to perform horizontal scanning displacement;
a second supporting body that has lower rigidity than the plurality of securing materials and the reinforcing material and that supports the first supporting body through the securing materials; and
a second driving portion that causes the second supporting body to deform to cause the mirror, together with the first supporting body, to perform vertical scanning displacement.

7. The scanning mirror device as set forth in claim 1, wherein
the plurality of securing materials supports the first supporting body in a plurality of areas on the first supporting body.

8. The scanning mirror device as set forth in claim 6, wherein
the plurality of securing materials supports the first supporting body in a plurality of areas on the first supporting body.

9. The scanning mirror device as set forth in claim 2, wherein
the reinforcing material is formed from silicon, and
the first supporting body and the second supporting body are formed from metal.

10. The scanning mirror device as set forth in claim 2, wherein
the reinforcing material is formed to avoid overlapping the mirror in a normal direction of the mirror.

11. The scanning mirror device as set forth in claim 3, wherein
the reinforcing material is formed to avoid overlapping the mirror in a normal direction of the mirror.

12. The scanning mirror device as set forth in claim 2, wherein
at least a portion of the reinforcing material that overlaps with the mirror in the normal direction of the mirror is formed from transparent material.

13. The scanning mirror device as set forth in claim 3, wherein
at least a portion of the reinforcing material that overlaps with the mirror in the normal direction of the mirror is formed from transparent material.
